(19) United States
(12) Patent Application Publication
(10) Pub. No.: US 2025/0303648 A1
(43) Pub. Date: Oct. 2, 2025

(54) Winding Machine and Method for Manufacturing Protective Helmet

(71) Applicant: COLLECTION GROUP TECHNOLOGY CO., LTD., Chiayi City (TW)

(72) Inventor: Tsung-Hsun YANG, Pingtung County (TW)

(21) Appl. No.: 19/090,471

(22) Filed: Mar. 26, 2025

(30) Foreign Application Priority Data
Mar. 27, 2024 (TW) 113111499

(51) Int. Cl. B29C 70/32; B29L 31/48

(52) U.S. Cl. CPC B29C 70/32; B29L 2031/4821

(57) ABSTRACT

A winding machine for manufacturing a protective helmet of the present application includes a rotating base, a winding mold and a yarn feeding module. The winding mold is disposed on the rotating base to be rotated or paused by the rotating base. The winding mold has a shell and a positioning pin assembly. The shell is disposed at a top of the rotating base, and the shell has an arc-shaped ring portion. The positioning pin assembly protrudes from the shell, and the positioning pin assembly has multiple positioning components, and the multiple positioning components are detachably assembled with the arc-shaped ring portion. The yarn feeding module is movable relative to the winding mold. Multiple elastic yarns released from the yarn feeding module are wound around the shell in cooperation with the positioning pin assembly.

### CROSS REFERENCE TO RELATED APPLICATION

The application claims the benefit of Taiwan application serial No. 113111499, filed on Mar. 27, 2024, and the entire contents of which are incorporated herein by reference.

### BACKGROUND OF THE INVENTION

### 1. Field of the Invention

The present application relates to manufacturing equipment and method for personnel protective equipment, particularly to a winding device for manufacturing a protective helmet and a method for manufacturing the protective helmet by using the winding machine.

### 2. Description of the Related Art

Protective helmets can be used for various activities, including impact protection and industrial purposes, such as construction workers, military personnel, workers or industrial machinery operators. Furthermore, protective helmets are also common in sports activities, for example, protective helmets can be used in ice hockey, cycling, auto racing, skiing, skating, skateboarding, equestrian activities, baseball, rugby, soccer, cricket, lacrosse, climbing and paintball games.

The manufacturing method of protective helmets involves winding multiple elastic yarns around a shell through a winding mold to form a wound formation (a semi-finished product with a wound shape), then removing the wound formation from the winding mold and placing it in a hot-press molding device for hot-press molding to produce a protective helmet. However, since the shell has an arc-shaped portion, during the process of winding the multiple elastic yarns around the shell, the elastic yarns easily slip from the arc-shaped portion, causing insufficient winding tightness of the elastic yarns on the arc-shaped portion, thus requiring production to be paused for readjustment, resulting in poor production efficiency.

In view of this, it is necessary to improve the conventional manufacturing method of protective helmets.

### SUMMARY OF THE INVENTION

To solve the above problems, it is an object of the present application to provide a method for manufacturing a protective helmet, which can significantly reduce the overall process time.

It is another objective of the present invention to provide a method for manufacturing a protective helmet, which can improve operational convenience.

It is yet another objective of the present invention to provide a method for manufacturing a protective helmet, which can improve product quality and yield rate.

It is further another object of the present application to provide a winding machine for manufacturing a protective helmet to implement the aforementioned method for manufacturing a protective helmet.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

The terms “first,” “second,” . . . and “N-th” described throughout this specification are primarily used to distinguish between different elements or features (such as components, directions, steps, etc.) and do not indicate the maximum or minimum quantity of such elements or features in the corresponding subject or method, nor do they imply any specific order or sequence.

As used herein, the term “engagement”, “coupling”, “assembly”, or similar terms is used to include separation of connected members without destroying the members after connection or inseparable connection of the members after connection. A person having ordinary skill in the art would be able to select according to desired demands in the material or assembly of the members to be connected.

A winding machine for manufacturing a protective helmet of the present application includes a rotating base, a winding mold and a yarn feeding module. The winding mold is disposed on the rotating base to be rotated or paused by the rotating base. The winding mold has a shell and a positioning pin assembly. The shell is disposed at a top of the rotating base, and the shell has an arc-shaped ring portion. The positioning pin assembly protrudes from the shell, and the positioning pin assembly has multiple positioning components, and the multiple positioning components are detachably assembled with the arc-shaped ring portion. The yarn feeding module is movable relative to the winding mold. Multiple elastic yarns released from the yarn feeding module are wound around the shell in cooperation with the positioning pin assembly.

A method for manufacturing a protective helmet of the present application includes: using the aforementioned winding machine for manufacturing a protective helmet to wind the multiple elastic yarns released from the yarn feeding module around the shell through positioning by the positioning pin assembly to form a wound formation; and removing the wound formation from the winding mold, and placing the wound formation in a hot-press molding device to hot-press mold the wound formation at a temperature ranging from 100° C. to 180° C. for 5 minutes to 15 minutes to obtain a helmet product.

Accordingly, through the use of the winding machine, the method for manufacturing a protective helmet of the present application can quickly and precisely wind elastic yarns to form the preliminary shape of a protective helmet. By the feature that the multiple positioning components are detachably assembled with the arc-shaped ring portion of the shell, the elastic yarns can be securely wound around the arc-shaped ring portion so as to prevent the elastic yarns from slipping off the arc-shaped ring portion. This eliminates the need to pause production for readjustment, thereby significantly reducing the overall process time and achieving remarkable improvement in production efficiency.

In an example, the shell may have a top wall and an annular wall, and the arc-shaped ring portion connects between the top wall and the annular wall. The positioning pin assembly has multiple first positioning pins arranged in a circular arrangement, and the multiple positioning pins protrude from the top wall. Thus, the first positioning pins can assist in positioning the elastic yarns during winding around the shell, thereby improving operational convenience.

In an example, the positioning pin assembly may have multiple second positioning pins arranged in a circular arrangement, and the multiple second positioning pins retractably protrude from the annular wall. Thus, the second positioning pins can assist in positioning the elastic yarns during winding around the shell without affecting the upward removal of the wound formation, thereby improving operational convenience.

In an example, the rotating base may have a column body and a gear plate. The winding mold is assembled at the top end of the column body. The gear plate can be fitted around the lower part of the column body. The rotating base may have a gear and an actuator. The gear can mesh with the gear plate, and the gear can be driven to rotate by the actuator. Thus, this allows control of the winding mold's rotation or pause through a simple structure, thereby achieving effects such as reduced manufacturing costs and improved assembly and operation convenience.

In an example, the shell may have multiple assembling grooves, and the multiple assembling grooves are located at the arc-shaped ring portion. Each of the multiple positioning components is disposed in a respective one of the assembling grooves. Thus, this facilitates the installation of positioning components on the arc-shaped ring portion, thereby providing convenience in assembly.

In an example, each of the multiple positioning components may have a block and multiple positioning pins. The block is configured to be mounted in a respective one of the assembling grooves, and the multiple positioning pins are connected to the block. Thus, the structure of each positioning component is simple and easily to be manufactured, thereby reducing manufacturing costs.

In an example, each of the multiple positioning components may have a magnetic member and a magnetically receptive member. The magnetic member is configured to be disposed in the a respective one of the multiple assembling grooves, and the magnetically receptive member assembled with the block of a respective one of the positioning components. Thus, by the magnetic attraction between the magnetically receptive member and the magnetic member, the effect of allowing the positioning component securely attached in the assembling groove can be achieved.

In an example, the method for manufacturing the protective helmet may further include placing the helmet product in a cold-press molding device to cold-press mold the helmet product at a temperature ranging from 40° C. to 60° C. for 3 minutes to 8 minutes. Thus, this allows the adhesive on the elastic yarns to cool and solidify so as to help the helmet product maintain its shape and resist deformation, thereby improving product quality and yield rate.

In an example, the method for manufacturing the protective helmet may further include performing a trimming process on the helmet product to remove rough edges. Thus, this makes the edges of the helmet product smoother to prevent from cutting hazard, thereby improving product quality.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a partial perspective view of a preferred embodiment of the winding machine according to the present application.

FIG. 2 is a side view of the rotating base and winding mold of the winding machine according to the present application.

FIG. 3 is a partial combined sectional view of the positioning component and shell of the winding machine.

FIG. 4 is a partial sectional view showing the positioning component magnetically attached to the assembling groove.

FIG. 5 shows a working state that multiple elastic yarns are wound on the shell.

FIG. 6 shows a working state that the elastic yarns are wound around the positioning pin assembly.

FIG. 7 is a sectional view showing the positioning component detached from the shell.

FIG. 8 shows a working state that the wound formation is removed from the winding mold.

FIG. 9 shows a hot-press molding step.

FIG. 10 is a side sectional structural view of the finished helmet product.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

The manufacturing method for protective helmet in this invention is implemented by a winding machined M. Therefore, the following contents will first describe the winding machine M to facilitate a better understanding for the details of the manufacturing method.

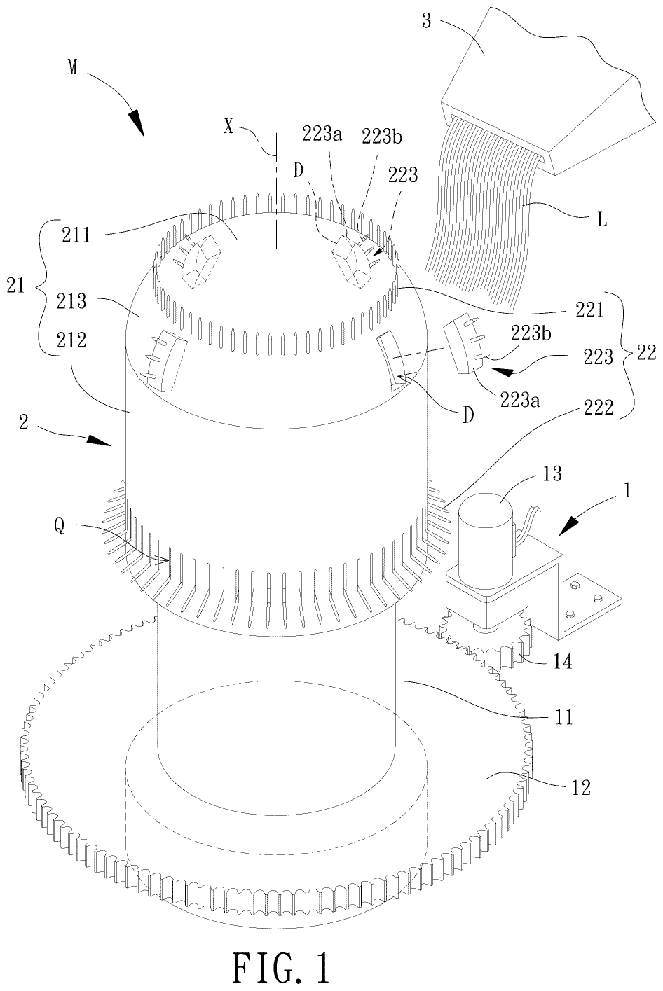

Referring to FIG. 1, which shows a preferred embodiment of the winding machine M, including a rotating base 1, a winding mold 2, and a yarn feeding module 3. The winding mold 2 is arranged on the rotating base 1, and the yarn feeding module 3 moves relative to the winding mold 2.

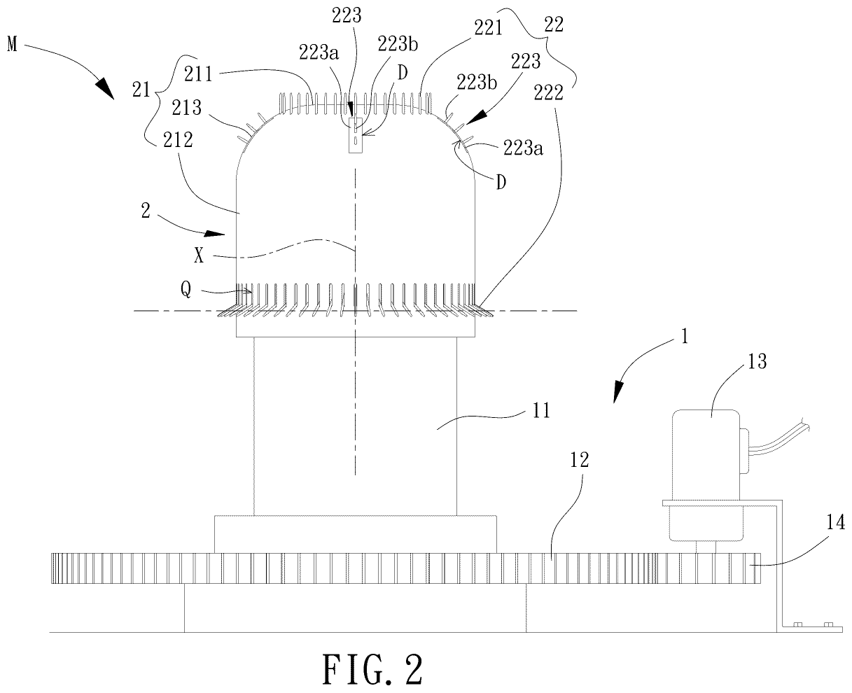

Referring to FIGS. 1 and 2, the form of the rotating base 1 is not limited by the present application and is not limited to the drawings disclosed in this embodiment as long as it can smoothly drive the winding mold 2 to rotate or pause. In this embodiment, the rotating base 1 may have a column body 11 and a gear plate 12. A top end of the column body 11 may be configured to be assembled by the winding mold 2, and the gear plate 12 may be fitted around the lower part of the column body 11. Furthermore, the rotating base 1 may have a gear 14 and an actuator 13, where the gear 14 may mesh with the gear plate 12 and be driven to rotate by the actuator 13. Thus, the actuator 13 can control the rotation direction and speed of the gear 14, and hence drive the gear plate 12 and the column body 11 to achieve the effects of controlling the rotation direction and speed of the winding mold 2; the configuration of the rotating base 1 of the present application is not limited to the above-mentioned configuration.

The winding mold 2 is disposed on the rotating base 1 to be rotated or paused by the rotating base 1, and the rotation direction of the winding mold 2 is controlled by the rotating base 1. The winding mold 2 has a shell 21 and a positioning pin assembly 22. The shell 21 is located at the top of the rotating base 1, and the positioning pin assembly 22 protrudes from the shell 21 to serve as positioning points during winding. The shell 21 may have a top wall 211 and an annular wall 212. The top wall 211 is located at the top of the shell 21 and may be generally formed with a hemispherical surface. The annular wall 212 connects to the top wall 211 and extends toward the gear plate 12. The shell 21 has an arc-shaped ring portion 213 connecting between the top wall 211 and the annular wall 212. Optionally, the shell 21 may have multiple assembling grooves D located at the arc-shaped ring portion 213. In this embodiment, four assembling grooves D are provided; the number of assembling grooves D is merely exemplary not limiting the present invention.

Referring to FIG. 1, the positioning pin assembly 22 may have multiple first positioning pins 221 and multiple second positioning pins 222. The first positioning pins 221 may protrude from the top wall 211 and are arranged in a circular arrangement/ring shape centered on a rotation axis X of the rotating base 1. In this embodiment, each first positioning pin 221 may be arranged vertically, generally extending parallel to the rotation axis X of the rotating base 1, or may be slightly inclined inward or outward to the rotation axis X. each first positioning pin 221 is provided based on a principle not interfering with the upward removal of an object wound on the shell 21.

The multiple second positioning pins 222 are also arranged in a circular arrangement/ring shape centered on the rotation axis X of the rotating base 1, and retractably protrude from the annular wall 212. The retraction and protrusion of the second positioning pins 222 may be controlled by electromagnetic means. as Alternatively, as an embodiment shown in FIG. 1, the shell 21 may have multiple holes Q penetrating the annular wall 212, with the number of holes Q corresponding to the number of second positioning pins 222. In this embodiment, each second positioning pin 222 may be pivotally mounted inside the shell 21, with the inner end of each second positioning pin 222 located inside the shell 21 and the outer end protruding through the corresponding hole Q in the annular wall 212.

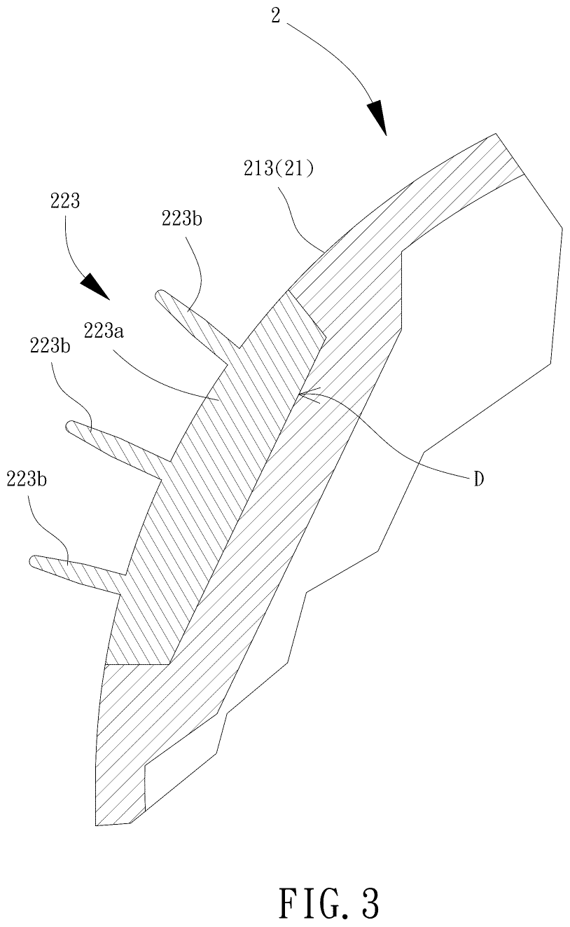

Referring to FIGS. 1 and 3, the positioning pin assembly 22 has multiple positioning components 223 that are detachably assembled with the arc-shaped ring portion 213 of the shell 21. In this embodiment, four positioning components 223 are provided; the number of positioning components 223 provided is merely exemplary not limiting the present invention. The positioning components 223 are located between the first positioning pins 221 and the second positioning pins 222, and each positioning component 223 is disposed in a respective assembling groove D. The present application does not limit the form of the positioning components 223. In an example as shown in FIG. 3, each positioning component 223 may have a block 223a and multiple positioning pins 223b. The block 223a may be configured to be mounted to or located in the assembling groove D, and the positioning pins 223b are connected to the block 223a, so that the positioning pins 223b protrude away from the arc-shaped ring portion 213 of the shell 21.

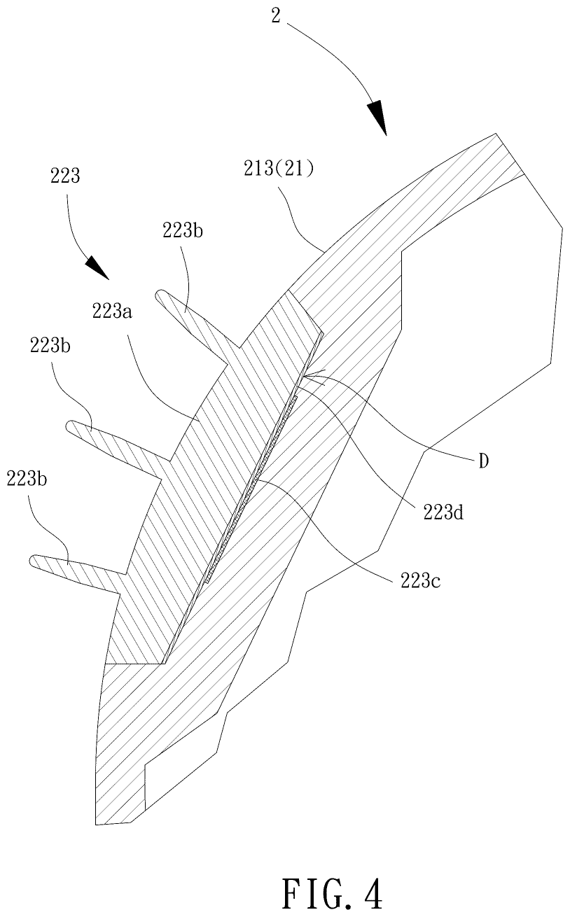

Referring to FIG. 4, preferably, the positioning component 223 may also have a magnetic member 223c and a magnetically receptive member 223d. The magnetic member 223c may be located in the assembling groove D, and the magnetically receptive member 223d may be coupled to the block 223a of the positioning component 223. The magnetic member 223c may be made of magnetically conductive material, so that the positioning component 223 can be firmly attached in the assembling groove D by the magnetic attraction between the magnetically receptive member 223d and the magnetic member 223c.

Referring to FIG. 1, the yarn feeding module 3 may be mounted on a robotic arm (not shown) to control the position and angle of the yarn feeding module 3 relative to the shell 21, so that multiple elastic yarns L released from the yarn feeding module 3 can be wound around the shell 21 in cooperation with the positioning pin assembly 22. The elastic yarns L may be fiber bundles made of materials such as Kevlar fiber, Dyneema fiber, or polyethylene fiber. Additionally, each elastic yarn L may be pre-coated with adhesive, or the yarn feeding module 3 may apply adhesive to the elastic yarns L while releasing the elastic yarns L. The adhesive may be, for example, a thermoplastic adhesive.

Based on the aforementioned winding machine M, a preferred embodiment of a method for manufacturing a protective helmet of the present application is provided and includes the following steps.

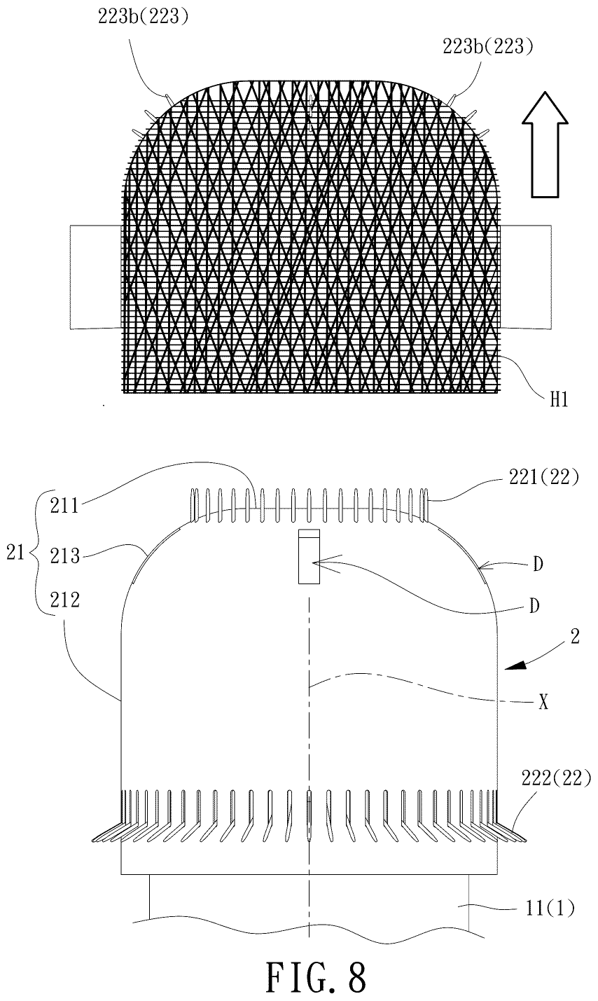

Referring to FIGS. 8, 9 and 10, said winding machine M is applied to wind multiple elastic yarns L released from the yarn feeding module 3 around the shell 21 through positioning by the positioning pin assembly 22 to form a wound formation H1; and the wound formation H1 is removed from the winding mold 2 and placed in a hot-press molding device 4 to hot-press mold the wound formation H1 at a temperature ranging from 100° C. to 180° C. for 5 minutes to 15 minutes to obtain a helmet product H2.

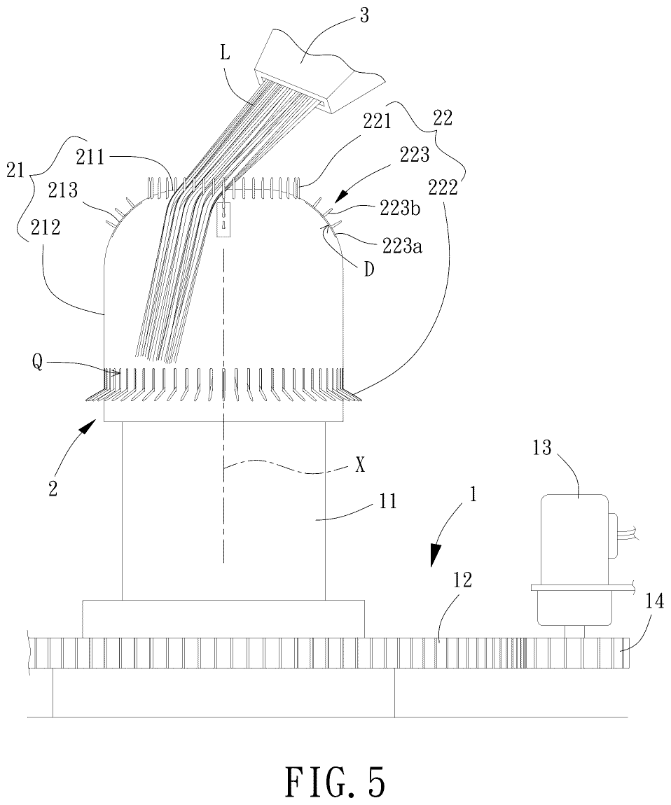

Specifically, referring to FIGS. 1 and 5, the position and angle of the yarn feeding module 3 relative to the shell 21 of the winding mold 2 are controlled by said robotic arm (not shown), so that multiple elastic yarns L released from the yarn feeding module 3 are wound around the shell 21 of the winding mold 2 through positioning by the positioning pin assembly 22 to form the wound formation H1 (shown in FIG. 8).

Referring to FIG. 5, more specifically, the multiple elastic yarns L released from the yarn feeding module 3 may first stretch over or cover the top wall 211 of the shell 21, with portions of the elastic yarns L passing among the first positioning pins 221, and the leading ends of the elastic yarns L hanging down to the annular wall 212 of the shell 21. Since the elastic yarns L are slightly adhesive, the portions covering the shell 21 will not be pulled away from the shell 21 during subsequent winding/yarn-pulling operations.

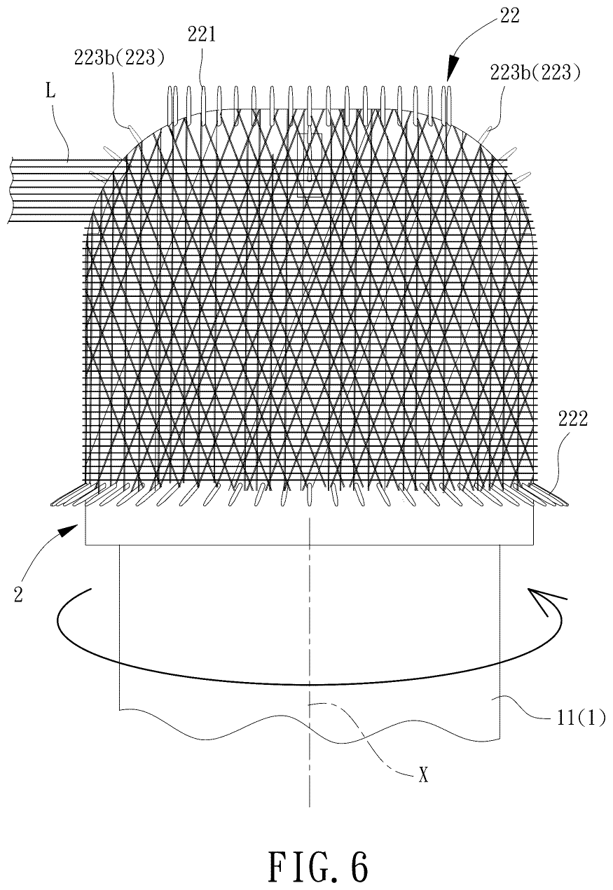

Referring to FIGS. 5 and 6, next, through the movement of the yarn feeding module 3 relative to the shell 21 and adjusting the joints of the robotic arm (not shown) to change the yarn feeding angle, the elastic yarns L can be wound in a V-pattern by hooking around second positioning pins 222, pulling across the top wall 211 to the opposite side, and similarly hooking around the second positioning pins 222 on the opposite side in a V-pattern. After tightly winding the elastic yarns L around the shell 21 several times in this manner, as shown in FIG. 6, the elastic yarns L are wound around the shell 21 from bottom to top (or from top to bottom) several times, centering on the rotation axis X.

By the arrangement that the positioning components 223 are located at the arc-shaped ring portion 213 of the shell 21, the elastic yarns L can hook around the positioning pins 223b of the positioning components 223, so that the elastic yarns L can be securely wound around the arc-shaped ring portion 213 of the shell 21 to prevent the elastic yarns L from slipping off the arc-shaped ring portion 213. After completing the above-mentioned operations, the wound formation H1, having a thickness approximately ranging from 5 mm to 12 mm, shown in FIG. 8 can be obtained. During the above-mentioned winding process, the rotating base 1 can be controlled to rotate or pause the winding mold 2 so as to produce the wound formation H1 more smoothly and more rapidly.

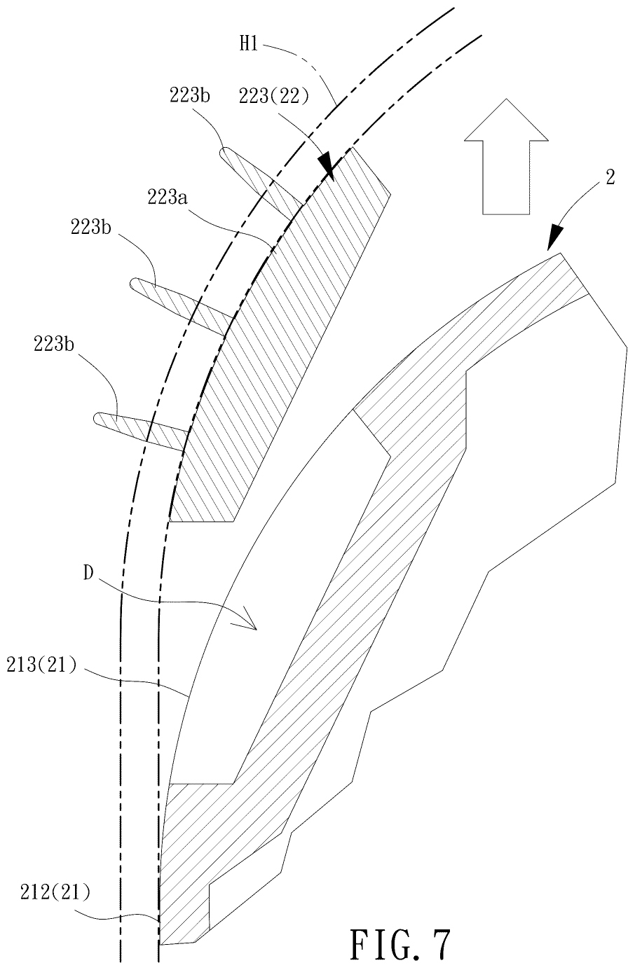

Referring to FIGS. 7 and 8, it should be particularly noted, when the wound formation H1 is pulled upward to remove from the winding mold 2 in this embodiment, the positioning components 223 are detached from the assembling grooves D and are separated from the shell 21 with the wound formation H1, so that the wound formation H1 can be smoothly pulled out and separated from the winding mold 2. After removing the wound formation H1, the positioning components 223 are removed from the wound formation H1 and placed back on the arc-shaped ring portion 213 of the shell 21 in preparation for forming the next wound formation H1.

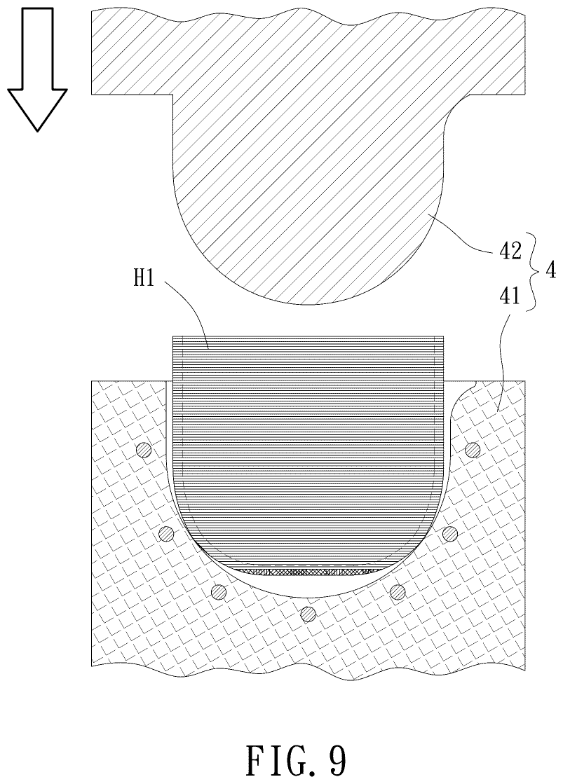

Referring to FIG. 9, the wound formation H1 is placed in a first mold 41 (exemplarily shown as a female mold) of the hot-press molding device 4, and then hot-press molded with a second mold 42 (exemplarily shown as a male mold) of the hot-press molding device 4. The hot-press molding temperature for the wound formation H1 approximately ranging from 100° C. to 180° C. for about 5 minutes to 15 minutes. In an exemplary example not limiting the present invention, said hot-press molding process is performed at 130° C. for 10 minutes.

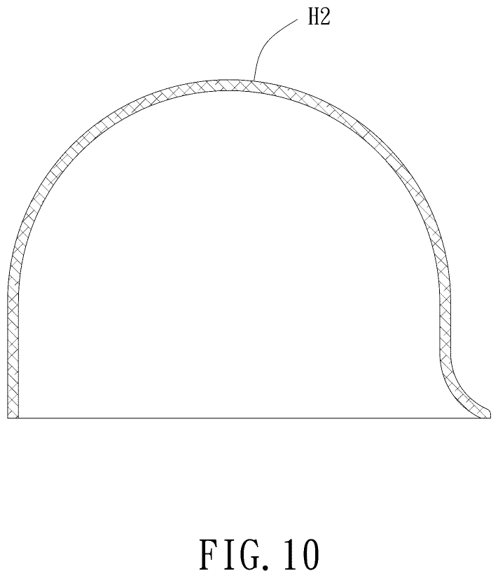

Referring to FIG. 10, after hot-press molding, the wound formation H1 can form the helmet product H2 with a more precise outer shape. Preferably, in this embodiment, the helmet product H2 may be further placed in a cold-press molding device for cold-press solidification process, so that the adhesive previously applied to the elastic yarns L can cool and solidify, thereby helping the helmet product H2 maintain its shape and resist deformation. The cold-press solidification temperature for the helmet product H2 approximately ranges from 40° C. to 60° C. for about 3 minutes to 8 minutes; In an exemplary example not limiting the present invention, cold-press solidification is performed at 50° C. for 5 minutes. Additionally, trimming process may be performed on the helmet product H2 by cutting or grinding to remove rough edges (such as burrs or flashes and the like), making the edges of the helmet product H2 smoother to prevent from cutting hazards.

In summary, the method for manufacturing a protective helmet of the present application can, quickly and precisely wind elastic yarns to form the preliminary shape of a protective helmet through the use of the winding machine. Since the positioning components are detachably assembled with the arc-shaped ring portion of the shell, the elastic yarns can be securely wound around the arc-shaped ring portion to prevent the elastic yarns from slipping off the arc-shaped ring portion; this eliminates the need to pause production for readjustment, thereby significantly reducing the overall process time and achieving remarkable improvement in production efficiency.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A winding machine for manufacturing a protective helmet, comprising:
a rotating base;
a winding mold disposed on the rotating base to be rotated or paused by the rotating base, wherein the winding mold has a shell and a positioning pin assembly, wherein the shell is disposed at a top of the rotating base, and the shell has an arc-shaped ring portion, wherein the positioning pin assembly protrudes from the shell, and the positioning pin assembly has multiple positioning components, and wherein the multiple positioning components are detachably assembled with the arc-shaped ring portion; and
a yarn feeding module configured to be movable relative to the winding mold, wherein multiple elastic yarns released from the yarn feeding module are wound around the shell in cooperation with the positioning pin assembly.

2. The winding machine for manufacturing the protective helmet as claimed in claim 1, wherein the shell has a top wall and an annular wall, and the arc-shaped ring portion connects between the top wall and the annular wall, wherein the positioning pin assembly has multiple first positioning pins arranged in a circular arrangement, and the multiple first positioning pins protrude from the top wall.

3. The winding machine for manufacturing the protective helmet as claimed in claim 2, wherein the positioning pin assembly has multiple second positioning pins arranged in a circular arrangement, and the multiple second positioning pins retractably protrude from the annular wall.

4. The winding machine for manufacturing the protective helmet as claimed in claim 1, wherein the rotating base has a column body and a gear plate, wherein the winding mold is assembled at a top end of the column body, and the gear plate is fitted around a lower part of the column body, wherein the rotating base has a gear and an actuator, the gear meshes with the gear plate, and the gear is driven to rotate by the actuator.

5. The winding machine for manufacturing the protective helmet as claimed in claim 1, wherein the shell has multiple assembling grooves, the multiple assembling grooves are located at the arc-shaped ring portion, and each of the multiple positioning components is disposed in a respective one of the multiple assembling grooves.

6. The winding machine for manufacturing the protective helmet as claimed in claim 5, wherein each of the multiple positioning components has a block and multiple positioning pins, the block is configured to be mounted to a respective one of the multiple assembling grooves, and the multiple positioning pins are connected to the block.

7. The winding machine for manufacturing the protective helmet as claimed in claim 6, wherein each of the multiple positioning components has a magnetic member and a magnetically receptive member, the magnetic member is configured to be disposed in a respective one the multiple assembling grooves, and the magnetically receptive member is assembled with the block of a respective one of the multiple positioning components.

8. A method for manufacturing a protective helmet, comprising:
using the winding machine for manufacturing the protective helmet according to claim 1 to wind the multiple elastic yarns released from the yarn feeding module around the shell through positioning by the positioning pin assembly to form a wound formation; and
removing the wound formation from the winding mold, and placing the wound formation in a hot-press molding device to hot-press mold the wound formation at a temperature ranging from 100° C. to 180° C. for 5 minutes to 15 minutes to obtain a helmet product.

9. The method for manufacturing the protective helmet as claimed in claim 8, further comprising placing the helmet product in a cold-press molding device to cold-press mold the helmet product at a temperature ranging from 40° C. to 60° C. for 3 minutes to 8 minutes.

10. The method for manufacturing the protective helmet as claimed in claim 8, further comprising performing a trimming process on the helmet product to remove rough edges of the helmet product.
